(19) United States
(12) Patent Application Publication
(10) Pub. No.: US 2009/0244747 A1
(43) Pub. Date: Oct. 1, 2009

(54) MAGNETIC TRANSFER MASTER CARRIER AND METHOD FOR PRODUCING THE SAME

(75) Inventors: Masakazu Nishikawa, Odawara-Shi (JP); Hideyuki Kubota, Odawara-Shi (JP); Makoto Nagao, Odawara-Shi (JP); Ryuji Sugita, Hitachi-Shi (JP); Takashi Komine, Hitachi-Shi (JP)

Correspondence Address: YOUNG & THOMPSON, 209 Madison Street, Suite 500, ALEXANDRIA, VA, 22314, US

(73) Assignee: FUJIFILM CORPORATION, Tokyo (JP)

(21) Appl. No.: 12/410,722

(22) Filed: Mar. 25, 2009

(30) Foreign Application Priority Data
Mar. 26, 2008 (JP) 2008-081779

(51) Int. Cl. G11B 5/86

(52) U.S. Cl. 360/17; G9B/5.308

(57) ABSTRACT

To provide a magnetic transfer master carrier obtained by forming a perpendicular magnetic anisotropy magnetic layer over a surface of an original master which has a concavo-convex pattern, placing a base material against the formed perpendicular magnetic anisotropy magnetic layer, and separating the base material.

### BACKGROUND OF THE INVENTION

1. Field of the Invention

The present invention relates to a magnetic transfer master carrier for magnetically transferring information to a perpendicular magnetic recording medium, and a method for producing the magnetic transfer master carrier.

2. Description of the Related Art

As magnetic recording media capable of recording information in a highly dense manner, perpendicular magnetic recording media are known. An information recording area of a perpendicular magnetic recording medium is composed of narrow tracks. Thus, a tracking servo technology for accurate scanning with a magnetic head within a narrow track width and for recording and reproducing a signal with a high S/N ratio is important to the perpendicular magnetic recording medium. To perform this tracking servo, it is necessary to record servo information, for example a servo signal for tracking, an address information signal, a reproduction clock signal, etc. as a so-called preformat at predetermined intervals on the perpendicular magnetic recording medium.

As a method for preformatting servo information on a perpendicular magnetic recording medium, there is, for example, a method wherein while a master carrier having a concavo-convex pattern with a magnetic layer on its surface, which corresponds to the servo information, is closely attached to the magnetic recording medium, a recording magnetic field (transfer magnetic field) is applied, and the pattern of the master carrier is magnetically transferred to the magnetic recording medium (refer to Japanese Patent Application Laid-Open (JP-A) Nos. 2003-203325 and 2000-195048 and U.S. Pat. No. 7,218,465, for example).

In this method, when the transfer magnetic field has been applied with the master carrier closely attached to the magnetic recording medium, a magnetic flux is absorbed into the patterned magnetic layer based upon the magnetized state of the master carrier, and the magnetic field is modulated correspondingly to the concavo-convex shape of the pattern. By means of this magnetic field modulated in the form of the pattern, only a predetermined place of the magnetic recording medium is magnetized in the magnetic field applying direction. Conventionally, magnetic materials with high saturation magnetization have been used as materials for magnetic layers of master carriers of this type.

The master carrier is produced, for example, by electroforming, using as a matrix an original master (silicon circular plate) having an inverted concavo-convex shape which is an inversion of the concavo-convex shape of the master carrier (refer to JP-A No. 2005-100605). In this kind of production method, firstly, a conductive magnetic film which is to be a part of the magnetic layer of the master carrier is formed on the inverted concavo-convex shape of the original master. As the material of the magnetic film, nickel is used, for example.

Parenthetically, a magnetic layer of a master carrier is roughly several tens of nanometers in thickness and is therefore very thin. For that reason, once a transfer magnetic field has been applied, a strong demagnetizing field is generated in the magnetic layer. When the demagnetizing field becomes strong, an effective magnetic field from the magnetic layer decreases even if a magnetic material with high saturation magnetization is used. Hitherto, an externally applied magnetic field has been further increased to secure transfer magnetic field strength. However, since the magnetic layer magnetization increase rate which is related to the increasing of the applied magnetic field is in proportion to the strength of the applied magnetic field, the above-mentioned situation is, in effect, tantamount to a situation where a strong magnetic field is applied to a material with low saturation magnetization. The transfer magnetic field strength becomes strong not only on the convex portion but also on the concave portion, and thus the difference in transfer magnetic field strength between the convex portion and the concave portion becomes small. When servo information is transferred to a magnetic recording medium, with the difference in transfer magnetic field strength between the convex portion and the concave portion being small, a reversal of magnetization is caused at a place (concave portion) that should not be magnetized, and the quality of the recording signal degrades, which is a problem.

In order to reduce the occurrence of the problem, the master carrier's magnetic layer itself needs to be sufficiently magnetized with a desired transfer magnetic field strength at least when the transfer magnetic field is applied, and a large magnetization value needs to be thusly obtained. If the magnetization value of the master carrier's magnetic layer itself can be sufficiently increased by a transfer magnetic field which has a minimum strength required to magnetize the magnetic recording medium, the difference in transfer magnetic field strength between the convex portion and the concave portion can be increased, which is particularly favorable.

Under such circumstances, as the material of the magnetic layer, use of a material having magnetic anisotropy in a direction perpendicular to the surface of the magnetic layer is being examined. It is thought that if such a material having perpendicular magnetic anisotropy is used for the magnetic layer of the master carrier, it is possible to minimize the strength of a transfer magnetic field applied as well as to easily increase the magnetization value of the magnetic layer by the transfer magnetic field.

However, it is not easy to form a master carrier having a magnetic layer with high perpendicular magnetic anisotropy. For instance, if the master carrier is produced by an electroforming method using a nickel conductive film as disclosed in JP-A No. 2005-100605 or the like, the perpendicular magnetic anisotropy of the magnetic layer of the master carrier obtained is low; when magnetic information is transferred to a perpendicular magnetic recording medium, using the master carrier thus obtained, a bridge arises between signals of 1/0/1 after the magnetic transfer, and thus an address signal cannot be decoded in some cases, which is a problem.

### BRIEF SUMMARY OF THE INVENTION

An object of the present invention is to provide a magnetic transfer master carrier including a magnetic layer having perpendicular magnetic anisotropy, and a method for producing the magnetic transfer master carrier.

Means for solving the problems are as follows.
<1> A magnetic transfer master carrier obtained by forming a perpendicular magnetic anisotropy magnetic layer over a surface of an original master which has a concavo-convex pattern, placing a base material against the formed perpendicular magnetic anisotropy magnetic layer, and separating the base material.
<2> The magnetic transfer master carrier according to <1>, wherein a functional layer is formed on the surface of the original master in advance, before the perpendicular magnetic anisotropy magnetic layer is formed.
<3> The magnetic transfer master carrier according to <1>, wherein perpendicular magnetic anisotropy of the perpendicular magnetic anisotropy magnetic layer is controlled.
<4> The magnetic transfer master carrier according to <1>, wherein the perpendicular magnetic anisotropy magnetic layer has a fine crystal grain structure.
<5> The magnetic transfer master carrier according to <2>, wherein the absolute value of an internal stress of the functional layer is 1 GPa or less.
<6> A magnetic transfer method including initially magnetizing a perpendicular magnetic recording medium in a perpendicular direction, closely attaching a magnetic transfer master carrier to the initially magnetized perpendicular magnetic recording medium, and magnetically transferring information to the perpendicular magnetic recording medium by applying a perpendicular magnetic field which acts in the opposite direction to the direction of the initial magnetization, with the perpendicular magnetic recording medium and the magnetic transfer master carrier closely attached to each other, wherein the magnetic transfer master carrier is the magnetic transfer master carrier according to any one of <1> to <5>.
<7> A method for producing a magnetic transfer master carrier, including forming a functional layer on a surface of an inverted concavo-convex pattern provided on an original master, forming a perpendicular magnetic anisotropy magnetic layer on a surface of the functional layer, and performing electroforming to form a base material, while the original master over which the perpendicular magnetic anisotropy magnetic layer has been formed serves as a matrix, wherein the magnetic transfer master carrier includes the base material having on its surface a concavo-convex pattern corresponding to information to be magnetically transferred to a perpendicular magnetic recording medium, and also includes the perpendicular magnetic anisotropy magnetic layer formed on a surface of the concavo-convex pattern, wherein the inverted concavo-convex pattern is an inversion of the concavo-convex pattern, and wherein the functional layer includes a release layer and a perpendicular magnetic anisotropy providing layer.
<8> The method according to <7>, further including removing the functional layer which remains on a surface of the magnetic transfer master carrier having been separated from the original master, after the electroforming.
<9> The method according to <7>, wherein the absolute value of an internal stress of the functional layer is 1 GPa or less.
<10> The method according to <7>, wherein the release layer is formed of NiW.
<11> The method according to any one of <7> to <10>, wherein the perpendicular magnetic anisotropy providing layer contains at least one of Pt and Ru.
<12> A magnetic transfer master carrier produced by the method according to any one of <7> to <11>.

According to the present invention, it is possible to solve the problems in related art and provide a magnetic transfer master carrier including a magnetic layer having perpendicular magnetic anisotropy, and a method for producing the magnetic transfer master carrier.

### BRIEF DESCRIPTION OF THE DRAWINGS

FIG. 1A is an explanatory diagram showing an initially magnetizing step in a perpendicular magnetic recording transfer method.

FIG. 1B is an explanatory diagram showing a closely attaching step in the perpendicular magnetic recording transfer method.

FIG. 1C is an explanatory diagram showing a magnetic transfer step in the perpendicular magnetic recording transfer method.

FIG. 2 is a partially cross-sectional view showing an example of a magnetic transfer master carrier.

FIG. 3A is an explanatory diagram showing an example of a method for producing an original master used in producing a magnetic transfer master carrier.

FIG. 3B is an explanatory diagram showing the example of the method for producing an original master used in producing a magnetic transfer master carrier.

FIG. 3C is an explanatory diagram showing the example of the method for producing an original master used in producing a magnetic transfer master carrier.

FIG. 3D is an explanatory diagram showing the example of the method for producing an original master used in producing a magnetic transfer master carrier.

FIG. 3E is an explanatory diagram showing the example of the method for producing an original master used in producing a magnetic transfer master carrier.

FIG. 3F is an explanatory diagram showing the example of the method for producing an original master used in producing a magnetic transfer master carrier.

FIG. 4A is an explanatory diagram showing a step of forming a release layer in a method for producing a magnetic transfer master carrier.

FIG. 4B is an explanatory diagram showing a step of forming a perpendicular magnetic anisotropy providing layer in the method for producing a magnetic transfer master carrier.

FIG. 4C is an explanatory diagram showing a step of forming a perpendicular magnetic anisotropy magnetic layer in the method for producing a magnetic transfer master carrier.

FIG. 4D is an explanatory diagram showing an electroforming step in the method for producing a magnetic transfer master carrier.

FIG. 4E is an explanatory diagram showing the method for producing a magnetic transfer master carrier.

FIG. 4F is an explanatory diagram showing a step of removing a functional layer in the method for producing a magnetic transfer master carrier.

FIG. 4G is an explanatory diagram showing a step of forming a protective layer in the method for producing a magnetic transfer master carrier.

FIG. 5 is a top view of a magnetic transfer master carrier.

FIG. 6 is an explanatory diagram showing a cross-section of a slave disk.

FIG. 7 is an explanatory diagram showing the direction in which a magnetic layer (recording layer) is magnetized after an initially magnetizing step.

FIG. 8 is an explanatory diagram showing a magnetic transfer step.

FIG. 9 is a schematic structural diagram of a magnetic field applying device used in a magnetic transfer step.

FIG. 10 is an explanatory diagram showing the direction in which a magnetic layer (recording layer) is magnetized after a magnetic transfer step.

### DETAILED DESCRIPTION OF THE INVENTION

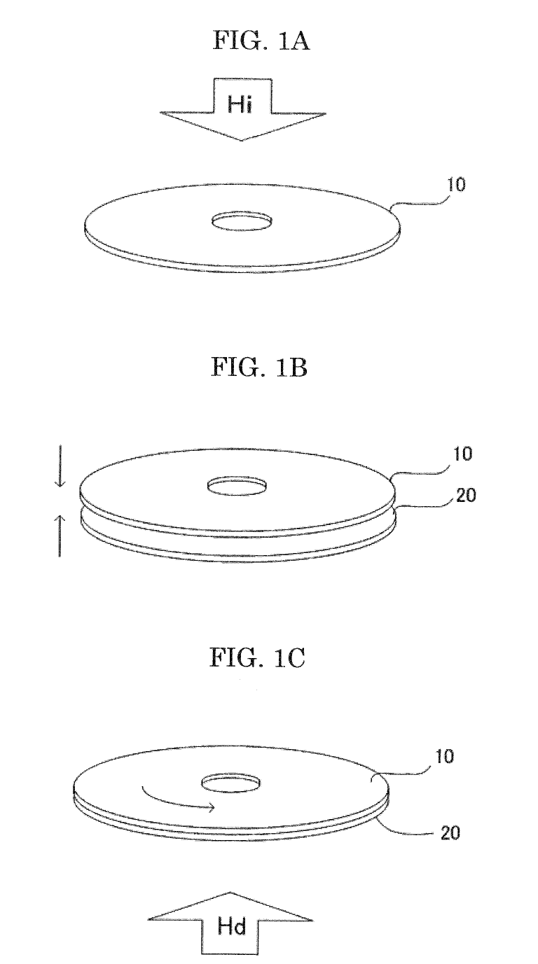

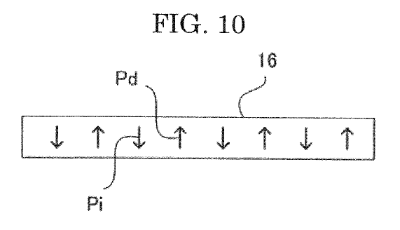

First of all, an outline of a magnetic transfer technique for perpendicular magnetic recording will be explained. FIGS. 1A to 1C are explanatory diagrams showing a magnetic transfer method with respect to perpendicular magnetic recording. In FIGS. 1A to 1C, 10 denotes a slave disk that is a perpendicular magnetic recording medium, and 20 denotes a master disk serving as a magnetic transfer master carrier.

FIG. 1A is an explanatory diagram showing an initially magnetizing step. As shown in FIG. 1A, the slave disk 10 is initially magnetized by applying a DC magnetic field (Hi) to a flat surface of the slave disk 10 from a perpendicular direction.

FIG. 1B is an explanatory diagram showing a closely attaching step. As shown in FIG. 1B, the slave disk 10 that has been initially magnetized and the master disk 20 are closely attached to each other.

FIG. 1C is an explanatory diagram showing a magnetic transfer step. As shown in FIG. 1C, information which the master disk 20 has is magnetically transferred to the slave disk 10 by applying a magnetic field (Hd) which acts in the opposite direction to the direction of the magnetic field (Hi) applied at the time of the initial magnetization.

### [Magnetic Transfer Master Carrier]

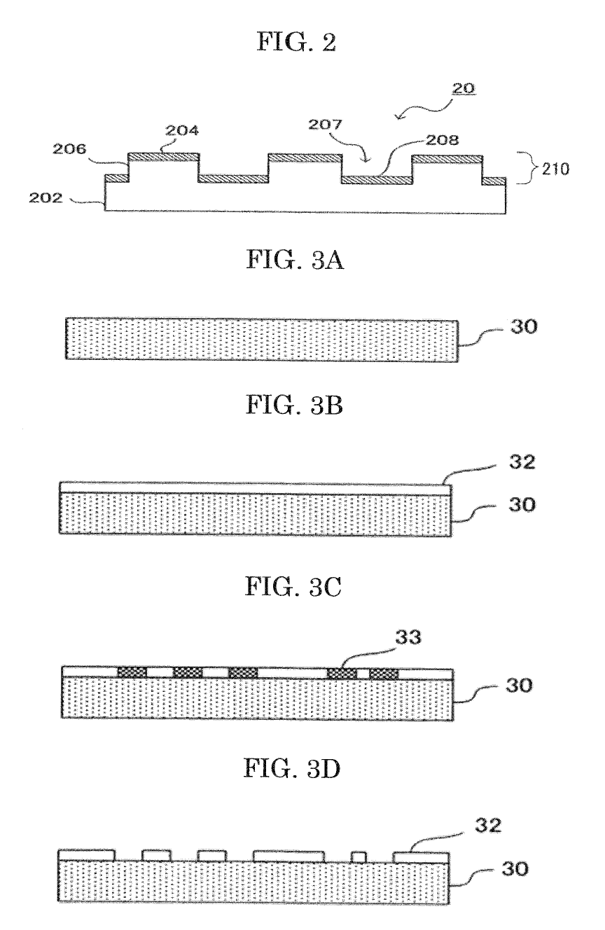

FIG. 2 is a partially cross-sectional view of the master disk (magnetic transfer master carrier) 20. This master disk 20 includes a base material 202, and a perpendicular magnetic anisotropy magnetic layer 204 formed over the surface of the base material 202. The base material 202 has on its surface a concavo-convex pattern 210 consisting of a convex portion 206 and a concave portion 207.

The concavo-convex pattern 210 corresponds to magnetic information to be transferred to the slave disk (perpendicular magnetic recording medium) 10. Examples of the magnetic information include servo information such as servo signals.

In the concavo-convex pattern 210, at least the convex portion 206 is provided with the perpendicular magnetic anisotropy magnetic layer 204 on its surface (apical surface). Additionally, in the present embodiment, a magnetic layer 208 is provided on the surface of the concave portion 207 for the sake of facilitation of production, etc.

The perpendicular magnetic anisotropy magnetic layer 204 formed on the surface (apical surface) of the convex portion 206 of the base material 202 constitutes a bit portion corresponding to a transfer signal. This bit portion is a portion to reverse an initial magnetization of a perpendicular magnetic recording medium (slave disk 10) and is equivalent to a transfer portion. Meanwhile, the concave portion 207 is equivalent to a non-transfer portion that does not contribute to a reversal of magnetization.

### (Base Material)

The material of the base material 202 can be selected from known materials, for example glass, synthetic resins such as polycarbonates, metals such as nickel and aluminum, silicon and carbon.

In the case where a magnetic transfer master carrier of the present invention is produced using a production method which includes an electroforming step, a material which can be electroformed, such as nickel, is used.

### (Perpendicular Magnetic Anisotropy Magnetic Layer)

The perpendicular magnetic anisotropy magnetic layer is a magnetic layer which has perpendicular magnetic anisotropy. The material used for the perpendicular magnetic anisotropy magnetic layer is an alloy or compound composed of at least one ferromagnetic metal selected from Fe, Co and Ni and at least one nonmagnetic substance selected from Cr, Pt, Ru, Pd, Si, Ti, B, Ta and O.

In the case where the perpendicular magnetic anisotropy magnetic layer is formed of CoPt, its perpendicular magnetic anisotropy can be controlled primarily by adjusting the sputter pressure and the Pt concentration at the time of formation of the magnetic layer.

The sputter pressure is preferably 0.2 Pa to 50 Pa, more preferably 0.2 Pa to 10 Pa. The Pt concentration is preferably 5 atom % to 50 atom %, more preferably 10 atom % to 25 atom %.

In the present embodiment, the expression “has perpendicular magnetic anisotropy” concerning the magnetic layer of the magnetic transfer master carrier is defined as the case where the ratio (Mpe/Min) of the magnetization value (Mpe) of a perpendicular magnetization curve to the magnetization value (Min) of an in-plane magnetization curve, calculated by the following method, is in the range of 0.4 to 2.0. The method for calculating Min and Mpe is as follows.

### <Method for Calculating Min and Mpe>

The same layer as the magnetic layer of the master carrier (master disk) and the same layer as a functional layer (release layer and perpendicular magnetic anisotropy providing layer) are formed over a glass substrate (2.5 inch in thickness) under the same condition as that at the time of production of the master carrier. The sample formed over the glass substrate is cut into a size of 5 mm×8 mm, then a magnetic field is applied in an in-plane direction and a perpendicular direction to the cut sample, using a vibrating sample magnetometer (VSM-C7, manufactured by TOEI INDUSTRY CO., LTD.), and the magnetization curves of the sample are thus measured.

Based upon the magnetization curves obtained, the magnetization value (Mpe) of the perpendicular magnetization curve and the magnetization value (Min) of the in-plane magnetization curve at an externally applied magnetic field strength equal to the strength of a transfer magnetic field are calculated

### <Particle State>

The perpendicular magnetic anisotropy magnetic layer preferably has a fine crystalline structure. Further, the crystalline structure is preferably in a dense state.

In the case where the perpendicular magnetic anisotropy magnetic layer has a fine crystalline structure, and the fine crystalline structure is in a dense state, a magnetic flux of a uniform width can be generated from the convex portion of the master carrier when a transfer perpendicular magnetic field is applied.

The particle state of the perpendicular magnetic anisotropy magnetic layer is judged in accordance with the following method.

In a master carrier producing process, a functional layer such as a release layer and a magnetic layer are formed over an original master, then the magnetic layer is irradiated with a focused ion beam (FIB) (FIB-2000, manufactured by Seiko Instruments Inc.), and an ultrathin section is thus obtained. The section is observed using a transmission electron microscope (TEM) (H-9000, manufactured by Hitachi, Ltd.).

An observed image is photographed with the TEM, the observed image is processed using image processing software, and the magnetic layer's crystal column diameter (MCD) and crystal column interval distance (MID) are calculated.

When MCD is 30 nm or less, the magnetic layer is judged to have a fine crystalline structure. When MID is 2 nm or less, the magnetic layer is judged to be in a dense state.

### (Underlayer)

In order to adjust the perpendicular magnetic anisotropy, magnetic anisotropy energy, saturation magnetization, nucleation magnetic field, etc. of the perpendicular magnetic anisotropy magnetic layer, an underlayer may be formed under the magnetic layer (between the magnetic layer and the base material).

The material of the underlayer is a metal, alloy or compound that contains at least one selected from Pt, Ru, Pd, Co, Cr, Ni, W, Ta, Al, P, Si, Ti, Ir and Mn. The material of the underlayer is preferably a platinum group metal such as Pt or Ru, or an alloy thereof The underlayer may be composed of a single layer or a plurality of layers.

The underlayer can be formed by a known method such as sputtering=The thickness of the underlayer is preferably 1 nm to 30 nm, more preferably 5 nm to 20 nm.

When the thickness of the underlayer is greater than 30 nm, the shape of the perpendicular magnetic anisotropy magnetic layer formed on the pattern of the master disk may degrade, thereby possibly leading to a degradation of the distribution of a transfer magnetic field, and a degradation of the quality of a recording signal.

When the thickness of the underlayer is less than 1 nm, the perpendicular magnetic anisotropy, magnetic anisotropy energy, saturation magnetization, nucleation magnetic field, etc. of the magnetic layer cannot be controlled in some cases.

### (Protective Layer and the Like)

A protective layer made, for example, of diamond-like carbon may be formed on the perpendicular magnetic anisotropy magnetic layer. The protective layer normally has a thickness of 10 nm or less. Further, a lubricant layer may be formed on the protective layer.

### [Method for Producing Magnetic Transfer Master Carrier]

An original master is used in producing the magnetic transfer master carrier (master disk 20) according to the present embodiment. The original master has an inverted concavo-convex pattern on its surface. The inverted concavo-convex pattern is an inversion of the concavo-convex pattern of the magnetic transfer master carrier. The original master is made of a known material such as silicon. The following explains a method for producing an original master.

### (Method for Producing Original Master)

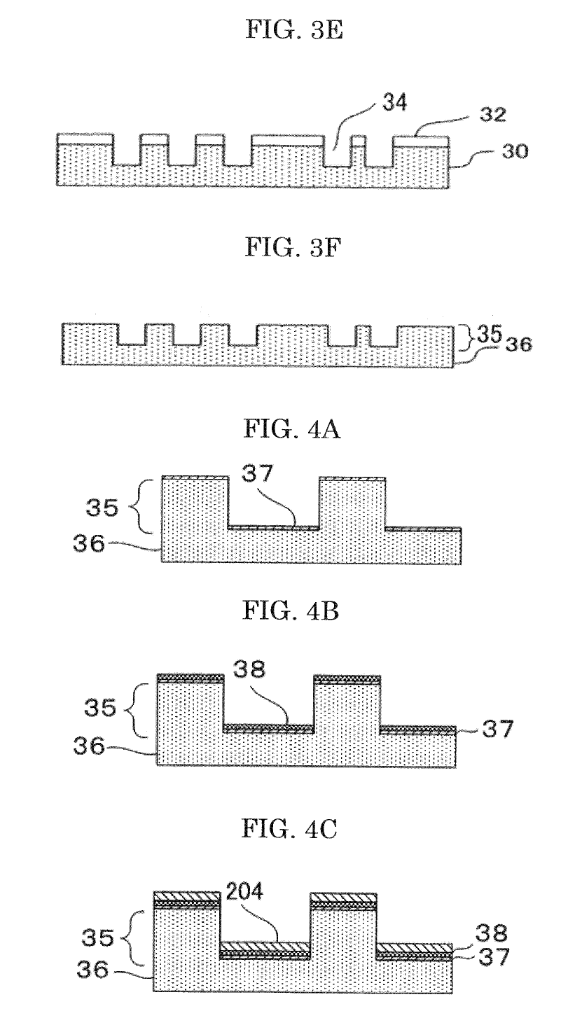

FIGS. 3A to 3F are explanatory diagrams showing a process of producing an original master used in producing a magnetic transfer master carrier.

As shown in FIG. 3A, an original plate (Si substrate) 30, which is a silicon wafer whose surface is smooth, is prepared, an electron beam resist solution is applied onto this original plate 30 by spin coating or the like so as to form a resist layer 32 thereon (see FIG. 3B), and the resist layer 32 is baked (pre-baked).

Next, the original plate 30 is set on a high-precision rotary stage or X-Y stage provided in an electron beam exposure apparatus (not shown), an electron beam modulated correspondingly to a servo signal is applied while the original plate 30 is being rotated, and a predetermined pattern 33 is formed on the substantially entire surface of the resist layer 32; for example, a pattern that corresponds to a servo signal and that linearly extends in radius directions from the rotational center toward each track is formed at portions corresponding to frames on the circumference by writing exposure (electron beam writing) (see FIG. 3C).

Subsequently, as shown in FIG. 3D, the resist layer 32 is developed, the exposed (written) portions are removed, and a coating layer having a desired thickness is formed by the remaining resist layer 32. This coating layer serves as a mask in a subsequent step (etching step). Additionally, the resist applied onto the original plate 30 can be of positive type or negative type; it should be noted that an exposed (written) pattern formed when a positive-type resist is used is an inversion of an exposed (written) pattern formed when a negative-type resist is used. After this developing process, a baking process (postbaking) is carried out to enhance the adhesion between the resist layer 32 and the original plate 30.

Subsequently, as shown in FIG. 3E, part of the original plate 30 is removed (etched) from an opening portion 34 of the resist layer 32, such that hollows having a predetermined depth are formed in the original plate 30. As to this etching, anisotropic etching is preferable in that an undercut (side etching) can be minimized. As such anisotropic etching, reactive ion etching (RIE) can be suitably employed.

Thereafter, as shown in FIG. 3Fi, the resist layer 32 is removed. Regarding the method for removing the resist layer 32, ashing can be employed as a dry method, and a removal method using a release solution can be employed as a wet method. By means of the ashing process, an original master 36 on which an inversion of a desired concavo-convex pattern (inverted concavo-convex pattern 35) is formed is produced.

### (Process of Producing Magnetic Transfer Master Carrier)

The method for producing a magnetic transfer master carrier according to the present embodiment includes at least (1) a step of forming a functional layer, (2) a step of forming a perpendicular magnetic anisotropy magnetic layer, and (3) an electroforming step.

### <Step of Forming Functional Layer>

The step of forming a functional layer is a step of forming a functional layer on the surface of the inverted concavo-convex pattern of the original master.

The term “functional layer” is a generic term for layer(s) formed between the perpendicular magnetic anisotropy magnetic layer and the surface of the inverted concavo-convex pattern of the original master in the process of producing a magnetic transfer master carrier. The functional layer pertains to a release layer and a perpendicular magnetic anisotropy providing layer.

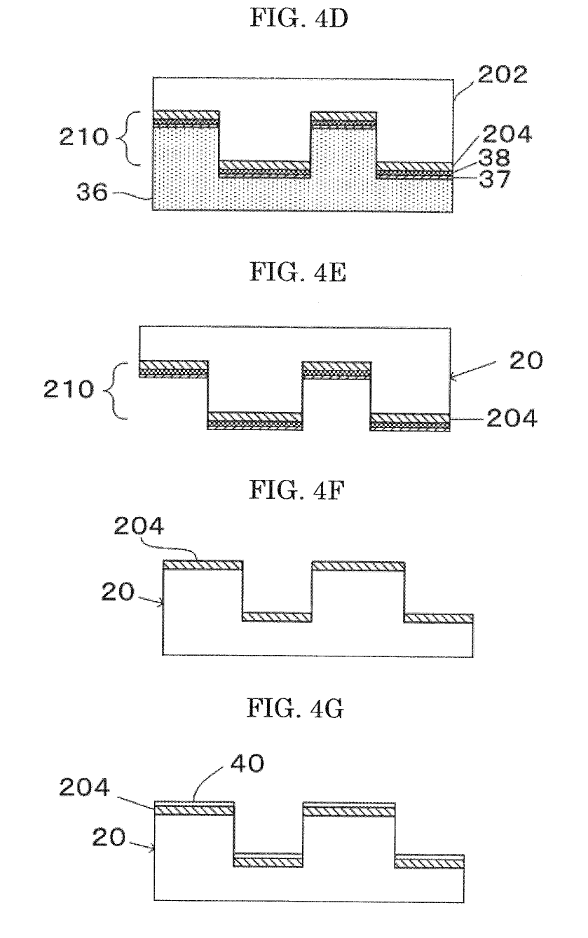

FIGS. 4A to 4G are explanatory diagrams showing a method for producing a magnetic transfer master carrier according to one embodiment. FIG. 4A is an explanatory diagram showing a step of forming a release layer 37, which is a component of the functional layer, on the surface of the inverted concavo-convex pattern 35 of the original master 36.

The release layer 37 is formed of NiW, NiAl, etc. The release layer 37 is formed at least on the surface of the concave portion of the inverted concavo-convex pattern 35. In the present embodiment, a release layer is also formed on the surface of the convex portion of the inverted concavo-convex pattern 35.

In general, the thickness of the release layer 37 is preferably 2 nm to 20 nm, more preferably 3 nm to 10 nm.

The method for forming the release layer 37 can be selected from a variety of metal deposition methods such as sputtering, PVD (physical vapor deposition), CVD (chemical vapor deposition) and ion plating.

FIG. 4B is an explanatory diagram showing a step in which on the release layer 37 that is a component of the functional layer, a perpendicular magnetic anisotropy providing layer 38 that is another component of the functional layer is formed.

The perpendicular magnetic anisotropy providing layer 38 is a layer to provide the magnetic layer with perpendicular magnetic anisotropy.

The perpendicular magnetic anisotropy providing layer 38 is formed of a metal, alloy or compound that contains at least one selected from Pt, Ru, Pd, Co, Cr, Ni, W, Ta, Al, P, Si and Ti.

As the material of the perpendicular magnetic anisotropy providing layer 38, a platinum group metal such as Pt or Ru, or an alloy thereof is particularly preferable. The perpendicular magnetic anisotropy providing layer 38 may be composed of a single layer or a plurality of layers.

The thickness of the perpendicular magnetic anisotropy providing layer 38 is preferably 1 nm to 30 nm, more preferably 5 nm to 20 nm.

Similarly to the method for forming the release layer 37, the method for forming the perpendicular magnetic anisotropy providing layer 38 can be selected from. a variety of metal deposition methods.

It is desirable that the absolute value of the internal stress (σ) of the functional layer be 1 GPa or less. When the absolute value of the internal stress (σ) of the functional layer is greater than 1 GPa, cracks may arise in the functional layer, thereby possibly causing destruction.

The internal stress (σ) can be calculated by the following method.

On a quartz ultrathin piece (thickness: 50 μm) formed as a rectangular strip (25 mm×5 mm), a functional layer is formed so as to have a thickness of 100 nm. The functional layer internal stress (σ) is calculated from the deformation amount of the quartz ultrathin piece, which is related to the form of the quartz ultrathin piece before and after the formation of the functional layer. The internal stress (σ) can be calculated using Stoney's equation shown below.

$$σ = \frac{{Eb}^{2} X}{3 ( 1 - v ) d {λ}^{2}}$$

In Stoney's equation, E denotes the Young's modulus of a quartz ultrathin piece, b denotes the thickness of the ultrathin piece, X denotes the deformation amount of the ultrathin piece, v denotes the Poisson's ratio of the ultrathin piece, d denotes the thickness of a functional layer, and λ denotes the length of the ultrathin piece.

It should be noted that since the value of the above-mentioned internal stress is a value obtained when the functional layer is formed so as to have a thickness of 100 nm, the actual internal stress is calculated by the expression odFu/100, where dFu denotes the actual functional layer thickness.

### <Step of Forming Perpendicular Magnetic Anisotropy Magnetic Layer>

The step of forming a perpendicular magnetic anisotropy magnetic layer is a step of forming a perpendicular magnetic anisotropy magnetic layer 204 on the perpendicular magnetic anisotropy providing layer 38. The magnetic layer 204 is formed by sputtering or the like. FIG. 4C is an explanatory diagram showing a step of forming the perpendicular magnetic anisotropy magnetic layer 204 on the perpendicular magnetic anisotropy providing layer 38.

### <Electroforming Step>

The electroforming step is a step of performing electroforming to form a base material having a concavo-convex pattern 210 on its surface, while the original master 36 over which the perpendicular magnetic anisotropy magnetic layer 204 has been formed serves as a matrix. FIG. 4D is an explanatory diagram showing a step of performing electroforming to form a base material 202 having the concavo-convex pattern 210 on its surface, while the original master 36 over which the perpendicular magnetic anisotropy magnetic layer 204 has been formed serves as a matrix.

In this step, the original master 36 is immersed in an electrolytic solution placed in an electroforming device, the original master 36 serves as an anode, and an electric current is passed between the anode and a cathode (not shown). When the electric current is passed, a metal plate (base material 202) is formed over the matrix. The concentration of the electrolytic solution, the pH, the manner in which the electric current is applied, etc. are required to be adjusted under an optimized condition where the metal plate does not warp.

The original master 36 over which the metal plate (base material 202) has been laid is removed from the electrolytic solution and then immersed in purified water placed in a release bath (not shown). In the release bath, the metal plate is separated from the original master 36 that serves as a rmatrix, and thus a magnetic transfer master carrier 20 having the concavo-convex pattern 210, which is an inversion of the concavo-conrvex pattern (inverted concavo-convex pattern 35) of the original master 36, is obtained (see FIG. 4E). The metal plate (base material 202) is formed into a round shape in an appropriate manner so as to obtain a magnetic transfer master carrier 20 having a predetermined shape. It may be formed in that manner after the after-mentioned step of removing a functional layer.

### <Step of Removing Functional Layer>

After the electroforming step, the perpendicular magnetic anisotropy providing layer 38 and the release layer 37 (which constitute the functional layer), in addition to the perpendicular magnetic anisotropy magnetic layer 204, are attached to the magnetic transfer master carrier 20 separated from the matrix. It is desirable that this functional layer be removed.

Accordingly, it is desirable that the method for producing a magnetic transfer master carrier according to the present embodiment further include a step of removing a functional layer (see FIG. 4F). The functional layer is removed by etching or the like. When the functional layer has been removed, nonmagnetic spacing does not remain on the surface of the magnetic transfer master carrier, thereby enabling clear magnetic transfer.

### <Step of Forming Protective Layer and the Like>

After the step of removing a functional layer, a protective layer 40 made, for example, of carbon may be formed over the surface of the magnetic transfer master carrier (see FIG. 4G). In general, the thickness of the protective layer 40 is supposed to be 10 nm or less. Further, a lubricant layer may be formed on the protective layer.

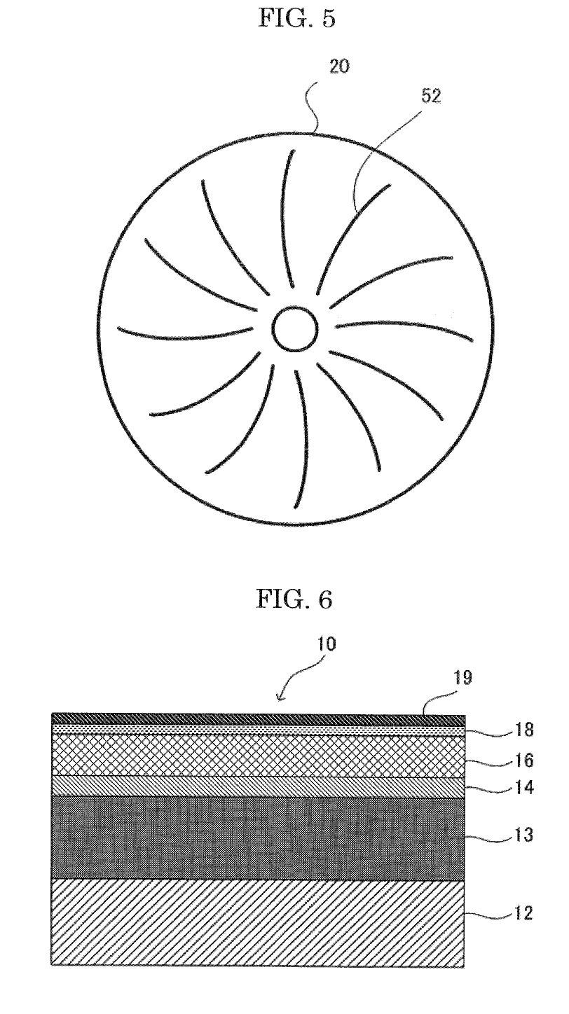

FIG. 5 is a top view of the master disk 20, which is a magnetic transfer master carrier. According to the above-mentioned method for producing a master carrier, it is possible to produce such a master disk 20 as shown in FIG. 5. A servo pattern 52 that is a concavo-convex pattern is formed on the surface of the master disk 20 shown in FIG. 5.

### [Perpendicular Magnetic Recording Medium]

The magnetic transfer master carrier of the present invention transfers magnetic information to a perpendicular magnetic recording medium.

The slave disk 10 shown in FIGS. 1A to 1C includes a disk-shaped substrate, and magnetic layer(s) formed over one or both surfaces of the substrate. Specific examples thereof include high-density hard disks. The following explains a perpendicular magnetic recording medium with reference to this slave disk as an example.

FIG. 6 is an explanatory diagram showing a cross-section of the slave disk 10. As shown in FIG. 6, the slave disk 10 includes a nonmagnetic substrate 12 made, for example, of glass, and also includes a soft magnetic layer (soft magnetic underlayer: SUL) 13, a nonmagnetic layer (intermediate layer) 14 and a magnetic layer (perpendicular magnetic recording layer) 16 formed over this substrate 12. Further, a protective layer 18 and a lubricant layer 19 are formed over the magnetic layer 16.

Note that although an example in which the magnetic layer 16 is formed over one surface of the substrate 12 is herein shown, an aspect in which magnetic layers are formed over both surfaces of the substrate 12 is possible as well.

The disk-shaped substrate 12 is made of a nonmagnetic material such as glass or Al (aluminum). After the soft magnetic layer 13 has been formed on this substrate 12, the nonmagnetic layer 14 and the magnetic layer 16 are formed over the soft magnetic layer 13.

The soft magnetic layer 13 is useful in that the perpendicular magnetization state of the magnetic layer 16 can be stabilized and sensitivity at the time of recording and reproduction can be improved. The material used for the soft magnetic layer 13 can be selected from soft magnetic materials, for example CoZrNb, FeTaC, FeZrN, FeSi alloys, FeAl alloys, FeNi alloys such as permalloy, and FeCo alloys such as permendur. The soft magnetic layer 13 is provided with magnetic anisotropy in radius directions (in a radial manner) from the center of the disk toward the outside.

The thickness of the soft magnetic layer 13 is preferably 20 nm to 2,000 nm, more preferably 40 nm to 400 nm.

The nonmagnetic layer 14 is provided in order to increase the magnetic anisotropy of the subsequently formed magnetic layer 16 in a perpendicular direction or for some other reason. As the material used for the nonmagnetic layer 14, Ti (titanium), Cr (chromium), CrTi, CoCr, CrTa, CrMo, NiAl, Ru (ruthenliu), Pd (palladium), Ta, Pt or the like is preferable. The nonmagnetic layer 14 is formed by depositing the material by means of sputtering. The thickness of the nonmagnetic layer 14 is preferably 10 nm to 150 nm, more preferably 20 nm to 80 nm.

The magnetic layer 16 is formed of a perpendicular magnetization film (which is configured such that magnetization easy axes in a magnetic film are oriented perpendicularly to the substrate), and information is to be recorded on this magnetic layer 16. As the material used for the magnetic layer 16, Co (cobalt), a Co alloy (CoPtCr, CoCr, CoPtCrTa, CoPtCrNbTa, CoCrB, CoNi, CoPt, etc.), Co alloy-SiO₂, Co alloy-TiO₂, Fe, an Fe alloy (FeCo, FePt, FeCoNi, etc.) or the like is preferable. High in magnetic flux density, any of these materials can have perpendicular magnetic anisotropy by adjustment of a deposition condition and/or its composition. The magnetic layer 16 is formed by depositing the material by means of sputtering. The thickness of the magnetic layer 16 is preferably 10 nm to 500 nm, more preferably 20 nm to 200 nm.

In the present embodiment, a disk-shaped glass substrate having an outer diameter of 65 mm is used as the substrate 12 of the slave disk 10, the glass substrate is set in a chamber of a sputtering apparatus, and the pressure is reduced to 1.33×10⁻⁵ Pa (1.0×10⁻⁷ Torr); thereafter, Ar(argon) gas is introduced into the chamber, and a first SUL having a thickness of 80 nm is deposited by sputtering with the use of a CoZrNb target provided in the chamber, the temperature of the substrate also in the chamber being set at room temperature. Subsequently, a Ru layer having a thickness of 0.8 nm is deposited on the first SUIL by sputtering with the use of a Ru target provided in the chamber. Further, a second SUL having a thickness of 80 nm is deposited on the Ru layer by sputtering with the use of a CoZrNb target. With a magnetic field of 50 Oe or higher being applied in a radius direction, the temperature of the SULs thus deposited by sputtering is raised to 200° C. and then cooled to room temperature.

Next, sputtering deposition is carried out by means of electric discharge under such a condition that the substrate temperature is made equal to room temperature, with the use of a Ru target. In this manner, the nonmagnetic layer 14 formed of Ru is deposited so as to have a thickness of 60 nm.

Thereafter, in a similar manner, Ar gas is introduced with the addition of oxygen gas, and sputtering deposition is carried out by means of electric discharge under such a condition that the substrate temperature is made equal to room temperature, with the use of a CoCrPt—SiO₂ target provided in the same chamber. In this manner, the magnetic layer 16 which is formed of CoCrPt—SiO₂ and has a granular structure is deposited so as to have a thickness of 25 nm.

By the above-mentioned process, the transfer magnetic disk (slave disk) 10, in which the soft magnetic layer, the nonmagnetic layer and the magnetic layer have been deposited over the glass substrate, can be produced.

### [Magnetic Transfer Method]

The following explains a method of magnetically transferring information to a perpendicular magnetic recording medium, using a magnetic transfer master carrier.

The magnetic transfer method of the present invention includes an initially magnetizing step, a closely attaching step and a magnetic transfer step. The following explains a magnetic transfer method according to one embodiment, referring to FIGS. 1A to 1C and some other figures.

### <Initially Magnetizing Step>

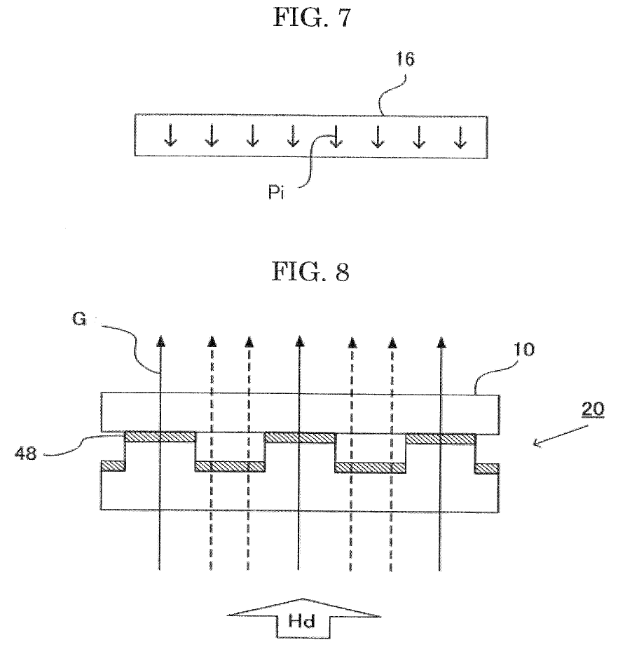

As shown in FIG. 1A, initial magnetization (DC magnetization) of the slave disk 10 is performed by generation of an initializing magnetic field Hi with the use of a device (magnetic field applying unit not shown) capable of applying a DC magnetic field perpendicularly to the surface of the slave disk 10. Specifically, it is performed by generating as the initializing magnetic field Hi a magnetic field which is greater than or equal to the coercive force Hc of the slave disk 10 in strength. In this initially magnetizing step, the magnetic layer 16 of the slave disk 10 is subjected to an initial magnetization Pi in one direction perpendicular to the disk surface, as shown in FIG. 7. It should be noted that this initially magnetizing step may be carried out by rotating the slave disk 10 relatively to the magnetic field applying unit.

### <Closely Attaching Step>

Next, a step (closely attaching step) is carried out in which, as shown in FIG. 1B, the master disk 20 and the initially magnetized slave disk 10 are laid on top of each other and closely attached to each other. In the closely attaching step, as shown in FIG. 1B, the surface of the master disk 20 where the protrusion pattern (concavo-convex pattern) has been formed and the surface of the slave disk 10 where the magnetic layer 16 has been formed are closely attached to each other with a predetermined pressing force.

If necessary, before closely attached to the master disk 20, the slave disk 10 is subjected to a cleaning process (burnishing) in which minute protrusions or attached dust on its surface is removed using a glide head, a polisher or the like.

As to the closely attaching step, there is a case where the master disk 20 is closely attached only to one surface of the slave disk 10 as shown in FIG. 1B, and there is another case where master disks are closely attached to both surfaces of a transfer magnetic disk, with magnetic layers having been formed over both the surfaces. The latter case is advantageous in that transfer to both the surfaces can be simultaneously performed.

### <Magnetic Transfer Step>

Next, the magnetic transfer step will be explained based upon FIG. 1C. To the slave disk 10 and the master disk 20 that have been closely attached to each other by the closely attaching step, a recording magnetic field Hd is generated in the opposite direction to the direction of the initializing magnetic field Hi by a magnetic field applying unit (not shown). Magnetic transfer is performed as a magnetic flux produced by generating the recording magnetic field Hd enters the slave disk 10 and the master disk 20.

In the present embodiment, the value of the recording magnetic field Hd is approximately equal to that of Hc of the magnetic material constituting the magnetic layer 16 of the slave disk 10.

As to the magnetic transfer, while the slave disk 10 and the master disk 20 closely attached to each other are being rotated by a rotating unit (not shown), the recording magnetic field Hd is applied by the magnetic field applying unit, and information in the form of the protrusion pattern, recorded on the master disk 20, is magnetically transferred to the magnetic layer 16 of the slave disk 10. Apart from this structure, a mechanism for rotating the magnetic field applying unit may be provided such that the magnetic field applying unit is rotated relatively to the slave disk 10 and the master disk 20.

A cross-section of the slave disk 10 and the master disk 20 in the magnetic transfer step is shown in FIG. 8. When the recording magnetic field Hd is applied, with the slave disk 10 closely attached to the master disk 20 having the concavo-convex pattern as shown in FIG. 8, a magnetic flux G becomes strong in a region where the convex portion of the master disk 20 and the slave disk 10 are in contact with each other, the recording magnetic field Hd causes the magnetization direction of a magnetic layer 48 of the master disk 20 to align with the direction of the recording magnetic field Hd, and thus the magnetic information is transferred to the magnetic layer 16 of the slave disk 10. Meanwhile, at the concave portion of the master disk 20, the magnetic flux G generated by the application of the recording magnetic field Hd is weaker than at the convex portion, and the magnetization direction of the magnetic layer 16 of the slave disk 10 does not change, so that the initially magnetized state remains unchanged.

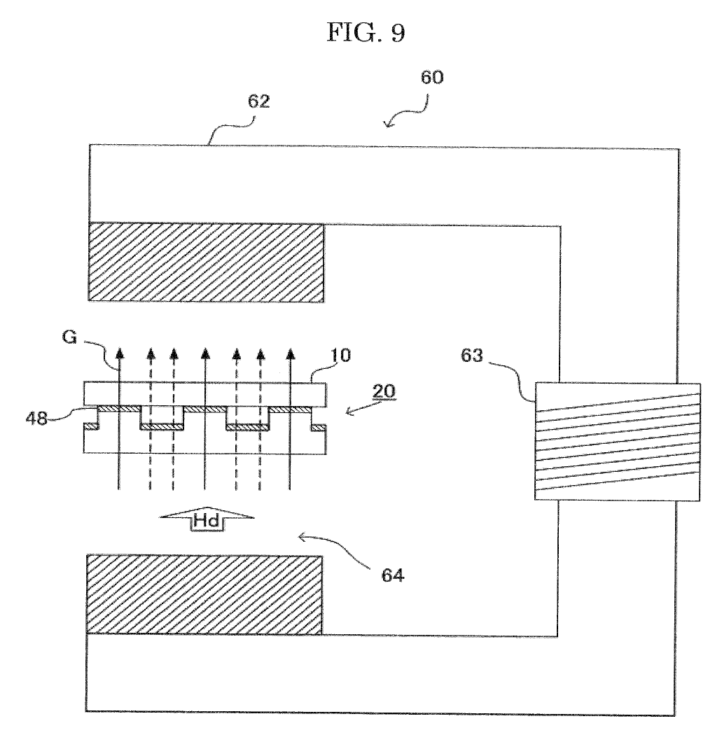

FIG. 9 shows in a detailed manner a magnetic transfer apparatus used for magnetic transfer. The magnetic transfer apparatus includes a magnetic field applying unit 60 composed of an electromagnet which is formed by winding a coil 63 around a core 62. By applying an electric current to the coil 63, a magnetic field is generated in a gap 64 perpendicularly to the master disk 20 and the magnetic layer 16 of the slave disk 10 which are closely attached to each other. The direction of the magnetic field generated can be changed depending upon the direction of the electric current applied to the coil 63. Therefore, this magnetic transfer apparatus makes it possible to initially magnetize the slave disk 10 and also to perform magnetic transfer.

In the case where this magnetic transfer apparatus is used to perform initial magnetization and then to carry out magnetic transfer, an electric current which flows in the opposite direction to the direction of an electric current applied to the coil 63 at the time of the initial magnetization is applied. This makes it possible to generate a recording magnetic field in the opposite direction to the magnetization direction at the time of the initial magnetization. In the magnetic transfer, while the slave disk 10 and the master disk 20 closely attached to each other are being rotated, the recording magnetic field Hd is applied by the magnetic field applying unit 60, and the information in the form of the protrusion pattern, recorded on the master disk 20, is magnetically transferred to the magnetic layer 16 of the slave disk 10; accordingly, the rotating unit (not shown) is provided. Apart from this structure, a mechanism for rotating the magnetic field applying unit 60 may be provided such that the magnetic field applying unit 60 is rotated relatively to the slave disk 10 and the master disk 20.

In the present embodiment, magnetic transfer is performed by applying a magnetic field which is equivalent in strength to 40% to 130%, preferably 50% to 120%, of the coercive force Hc of the magnetic layer 16 of the slave disk TO used in the present embodiment.

Thus, on the magnetic layer 16 of the slave disk 10, information of a magnetic pattern, such as a servo signal, is recorded as a recording magnetization Pd which acts in the opposite direction to the direction of the initial magnetization Pi (see FIG. 10).

A perpendicular magnetic recording medium produced by the method according to the above-mentioned embodiment of the present invention will be used, installed in a magnetic recording and reproducing device such as a hard disk device, for example. This makes it possible to obtain a high-recording-density magnetic recording and reproducing device with high servo precision and excellent recording and reproducing properties.

### EXAMPLES

The following explains Examples of the present invention. It should, however, be noted that the present invention is not confined to these Examples in any way.

### Example 1

### [Production of Magnetic Transfer Master Carrier (Master Disk)]

### (Production of Original Master)

An electron beam resist was applied onto an 8 inch Si wafer (silicon substrate) by spin coating so as to have a thickness of 100 nm. After the application, the resist on the substrate was exposed using a rotary electron beam exposure apparatus, then the exposed resist was developed, and a resist Si substrate having a concavo-convex pattern was thus produced.

Thereafter, the substrate was subjected to reactive etching, with the resist used as a mask, and the concave portion of the concavo-convex pattern was thusly enlarged downward. After this etching, the resist remaining on the substrate was removed by washing with a solvent in which the resist was soluble. After the removal, the substrate was dried, and the dried substrate was used as an original master for producing a magnetic transfer master carrier.

The pattern used in Example 1 had a reference signal length of 80 nm and a total sector number of 120 and was composed of the following pattern: preamble (40 bits)/SAM (6 bits)/sector code (8 bits)/cylinder code (32 bits)/burst. The SM section represents “001010”, the sector code employs binary conversion, and the cylinder code employs gray conversion. The burst section was composed of ordinary four bursts (each burst accounts for 16 bits). Manchester encoding was employed. (Production of Master Carrier by Plating) A layer (release layer) containing 10 at. % of NiW was formed on the original master by sputtering so as to have a thickness of 5 nm under an argon pressure of 1 Pa. A Pt layer (perpendicular magnetic anisotropy providing layer) was formed on the release layer by sputtering so as to have a thickness of 5 nm under an argon pressure of 1 Pa. Further, a Ru layer (perpendicular magnetic anisotropy providing layer) was formed on the Pt layer by sputtering so as to have a thickness of 10 nm under an argon pressure of 2 Pa. After the formation of the Ru layer, a layer (magnetic layer) containing 20 at. % of CoPt was formed on the Ru layer by sputtering so as to have a thickness of 40 nm. Thereafter, the original master over which the release layer, the Pt layer, the Ru layer and the magnetic layer had been formed was immersed in a sulfamic acid Ni bath, and a Ni film having a thickness of 200 μm was formed by electrolytic plating Subsequently, the Ni film was separated from the original master. The Pt layer, the Ru layer and the release layer, in addition to the magnetic layer, were attached to the surface of the Ni film when the Ni film had been separated from the original master. Accordingly, after the Ni film had been separated, layers other than the magnetic layer, such as the release layer, were removed by etching and washing. As described above, a Ni film (magnetic transfer master carrier) having a magnetic layer on its surface was obtained.

### [Production of Perpendicular Magnetic Recording Medium]

A soft magnetic layer, a first nonmagnetic orientation layer, a second nonmagnetic orientation layer, a magnetic recording layer and a protective layer were formed, in this order, over a 2.5 inch glass substrate by sputtering. Further, a lubricant layer was formed on the protective layer by dipping.

As the material of the soft magnetic layer, CoZrNb was used. The soft magnetic layer had a thickness of 100 nm. The glass substrate was placed facing the CoZrNb target, Ar gas was introduced such that the pressure became 0.6 Pa, and the soft magnetic layer was deposited at 1,500 W DC.

As the first nonmagnetic orientation layer, a 5 nm layer of Ti was formed. As the second nonmagnetic orientation layer, a 6 nm layer of Ru was formed.

As to the first nonmagnetic orientation layer, the glass substrate and the soft magnetic layer were placed facing a Ti target, Ar gas was introduced such that the pressure became 0.5 Pa, electric discharge was performed at 1,000 W DC, and a Ti seed layer was deposited so as to have a thickness of 5 nm. After the first nonmagnetic orientation layer had been formed, the glass substrate, the soft magnetic layer and the first nonmagnetic orientation layer were placed facing a Ru target, Ar gas was introduced such that the pressure became 0.8 Pa, electric discharge was performed at 900 W DC, and the second nonmagnetic orientation layer was deposited so as to have a thickness of 6 nm.

As the magnetic recording layer, a 18 nm layer of CoCrPtO was formed. The glass substrate, the soft magnetic layer, the first nonmagnetic orientation layer and the second nonmagnetic orientation layer were placed facing a CoCrPtO target, Ar gas containing 0.06% of O₂ was introduced such that the pressure became 14 Pa, electric discharge was performed at 290 W DC, and the magnetic recording layer was produced.

After the magnetic recording layer had been formed, the glass substrate, the soft magnetic layer, the first nonmagnetic orientation layer, the second nonmagnetic orientation layer and the magnetic recording layer were placed facing a C (carbon) target, Ar gas was introduced such that the pressure became 0.5 Pa, electric discharge was performed at 1,000 W DC, and a C protective layer (4 nm in thickness) was formed. The coercive force of this recording medium was adjusted to 334 kA/m (4.2 kOe).

Further, a PFPE lubricant was applied over the medium by dipping so as to have a thickness of 2 nm.

As described above, a perpendicular magnetic recording medium was produced.

### (Magnetic Transfer Step)

The perpendicular magnetic recording medium was initially magnetized. The strength of a magnetic field applied at the time of the initial magnetization (initial magnetic field strength) was 10 kOe.

The magnetic transfer master carrier was placed facing the initially magnetized perpendicular magnetic recording medium, and these were closely attached to each other at a pressure of 0.7 MPa. With these closely attached to each other, a magnetic field was applied, and magnetic transfer was thus performed. The strength of the magnetic field used for the magnetic transfer was 4.6 kOe. After the magnetic field had finished being applied, the magnetic transfer master carrier was separated from the perpendicular magnetic recording medium.

### (Evaluation of Perpendicular Magnetic Anisotropy)

A functional layer (a release layer, a Pt layer and a Ru layer) and a magnetic layer which are the same as those of the magnetic transfer master carrier of Example 1 were formed over a glass substrate (2.5 inch in thickness) under the same condition as Example 1. The sample formed over the glass substrate was cut into a size of 5 mm×8 mm. Then a magnetic field was applied in an in-plane direction and a perpendicular direction to the cut sample, using a vibrating sample magnetometer (VSM-C7, manufactured by TOEI INDUSTRY CO., LTD.), and the magnetization curves of the sample were thus measured. Based upon the magnetization curves obtained, the magnetization value (Mpe) of the perpendicular magnetization curve and the magnetization value (Min) of the in-plane magnetization curve at an externally applied magnetic field strength equal to the strength of a transfer magnetic field were calculated. Provided that Mpe/Min was in the range of 0.4 to 2.0, the sample was judged to have perpendicular magnetic anisotropy.

As to the result of Example 1, Mpe/Min was 1.9, which means that the sample had perpendicular magnetic anisotropy. The result is shown in Table 1.

(Evaluation of Particle State of Magnetic Layer) In a magnetic transfer master carrier producing process, a functional layer (a release layer, a Pt layer and a Ru layer) and a magnetic layer were formed on an original master, then the magnetic layer was irradiated with a focused ion beam (FIB) (FIB-2000, manufactured by Seiko Instruments Inc.), and an ultrathin section was thus obtained. The section was observed using a transmission electron microscope (TEM) (H-9000, manufactured by Hitachi, Ltd.).

An observed image was photographed with the TEM, the observed image was processed using image processing software, and the magnetic layer's crystal column diameter (MCD) and crystal column interval distance (MID) were calculated. When MCD was 30 nm or less, the magnetic layer was judged to have a fine crystalline structure. When MID was 2 nm or less, the magnetic layer was judged to be in a dense state.

As to the result of Example 1, MCD was 15 nm, and MID was 0.5 nm. The result is shown in Table 1.

### (Evaluation of Functional Layer Internal Stress)

On a quartz ultrathin piece (thickness: 50 μm) formed as a rectangular strip (25 mm×5 mm), a functional layer (a release layer, a Pt layer and a Ru layer) was formed so as to have a thickness of 100 nm. The functional layer internal stress (σ) was calculated from the deformation amount of the quartz ultrathin piece, which was related to the form of the quartz ultrathin piece before and after the formation of the functional layer. The internal stress (σ) was calculated using Stoney's equation shown below.

$$σ = \frac{{Eb}^{2} X}{3 ( 1 - v ) d {λ}^{2}}$$

In Stoney's equation, E denotes the Young's modulus of a quartz ultrathin piece, b denotes the thickness of the ultrathin piece, X denotes the deformation amount of the ultrathin piece, v denotes the Poisson's ratio of the ultrathin piece, d denotes the thickness of a functional layer, and λ0 denotes the length of the ultrathin piece.

It should be noted that since the value of the above-mentioned internal stress is a value obtained when the functional layer was formed so as to have a thickness of 100 nm, the actual internal stress was calculated by the expression odFu/100, where dFu denotes the actual functional layer thickness.

As to the result of Example 1, the internal stress was 0.5 GPa. The result is shown in Table 1.

### (Evaluation of Durability of Master Disk)

A mock transfer and close attachment test was carried out 10,000 times, using the same master disk (magnetic transfer master carrier) and slave disks. The pressure for close attachment in the mock close attachment test was set at 1 Pa.

Magnetic transfer was carried out on 100 perpendicular magnetic recording media, using the master disk that had undergone the mock close attachment test. The surfaces of the media that had undergone the magnetic transfer were measured for the numbers of surface defects, using an optical inspection apparatus (RS-1350, manufactured by Hitachi Electronics Engineering Co., Ltd.).

In the case where the number of defects measured concerning one magnetic transfer medium was three or more, the medium was judged to be defective. When the number of media judged to be defective was five or more per 100 media, the master disk was judged to be “not durable” (C); when the number of media judged to be defective was two to four per 100 media, the master disk was judged to be “durable” (B); and when the number of media judged to be defective was one or less per 100 media, the master disk was judged to be “excellent in durability” (A).

The evaluation of the durability of the master disk of Example 1 was A. The result is shown in Table 1.

### (Evaluation of Servo Signal Quality)

As to a perpendicular magnetic recording medium which had been provided with a magnetic layer, the TAA (track average amplitude) reproduction output of a preamble section was detected for all sectors. As an evaluating device, LS-90 manufactured by Kyodo electronics line was used. As a magnetic head, a GMR head with a read width of 120 nm and a write width of 200 nm was used.

The region lying between 20 mm and 32 mm in radius was measured at 1 mm intervals, and the overall average S/N (PS/N) of the preamble section was calculated. S/N for reference was calculated (HS/N) by recording signals of the same bit length in similar radial positions. The ratio (PS/N)/(HS/N) was calculated. When this ratio was 95% or greater, the servo signal quality was judged to be “excellent” (A); when this ratio was greater than or equal to 85% and less than 95%, the servo signal quality was judged to be “acceptable” (B); and when this ratio was less than 85%, the servo signal quality was judged to be “poor” (C). The servo signal quality was thus evaluated.

This ratio in Example 1 was 105%, which means excellent servo signal quality. The result is shown in Table 1.

### (Evaluation of Servo PES)

In addition to the evaluation of the servo signal quality, a servo PES (position error signal) was evaluated. As an evaluating device, BITFINDER manufactured by IMES Co., Ltd. was used. In the evaluation, a VCM mode was employed, the above-mentioned GMR head was attached to the device, and the servo following was evaluated. The evaluation of the servo PES was carried out by measuring the PES in a servo following state. The standard deviation (σ) was calculated from PES measurement values of sectors for 50 rotations. When the 3σ value was equivalent to less than 15% of the track pitch (TP), the servo PES was judged to be “superior” (A); and when the 3σ value was equivalent to 15% or greater of the track pitch (TP), the servo PES was judged to be “inferior” (B).

As to the result of Example 1, the 3σ value was 6%, which means a superior servo PES. The result is shown in Table 1.

### Example 2

A magnetic transfer master carrier was produced in a manner similar to Example 1, except that the Ru layer (perpendicular magnetic anisotropy providing layer) was changed to a Ta layer (10 nm in thickness).

The magnetic transfer master carrier of Example 2 produced was evaluated in a manner similar to Example 1. The results are shown in Table 1.

### Example 3

A magnetic transfer master carrier was produced in a manner similar to Example 1, except that the material of the release layer was changed from NiW to NiAl.

The magnetic transfer master carrier of Example 3 produced was evaluated in a manner similar to Example 1. The results are shown in Table 1.

### Example 4

A magnetic transfer master carrier was produced in a manner similar to Example 1, except that the argon pressure at the time of the formation of the functional layer (the release layer, the Pt layer and the Ru layer) was changed to 0.05 Pa.

The magnetic transfer master carrier of Example 4 produced was evaluated in a manner similar to Example 1. The results are shown in Table 1.

### Example 5

A magnetic transfer master carrier was produced in a manner similar to Example 1, except that the Ru layer (perpendicular magnetic anisotropy providing layer) was changed to a Pt layer (20 nm in thickness).

The magnetic transfer master carrier of Example 5 produced was evaluated in a manner similar to Example 1. The results are shown in Table 1.

### Example 6

A magnetic transfer master carrier was produced in a manner similar to Example 1, except that the material of the magnetic layer was changed to (CoPt 20 at. %)_{—}88 vol %-SiO₂_{_{—}}12 vol %.

The magnetic transfer master carrier of Example 6 produced was evaluated in a manner similar to Example 1. The results are shown in Table 1.

### Comparative Example 1

A magnetic transfer master carrier was produced in a manner similar to Example 17 except that none of the release layer, the Pt layer and the Ru layer were formed, and that a magnetic layer (FeCo 20 at. %) was directly formed on the original master so as to have a thickness of 40 nm.

The magnetic transfer master carrier of Comparative Example 1 produced was evaluated in a manner similar to Example 1. The results are shown in Table 1.

### Comparative Example 2

A magnetic transfer master carrier was produced in a manner similar to Example 1, except that the material of the release layer was changed from NiW to Ni.

The magnetic transfer master carrier of Comparative Example 2 produced was evaluated in a manner similar to Example 1. The results are shown in Table 1.

TABLE 1

| | Perpendicular | | | | | | | |
|---|---|---|---|---|---|---|---|---|
| | magnetic | | | | | | Functional layer | |
| | anisotropy | | Particle state | | Dense state | | internal stress | |
| | Mpe/ | | MCD | | MID | | σdFu/100 | |
| | Min | Evaluation | (nm) | Evaluation | (nm) | Evaluation | (GPa) | Evaluation |
| Example 1 | 1.9 | A | 15 | A | 0.5 | A | 0.5 | A |
| Example 2 | 1.4 | A | 20 | A | 0.6 | A | 0.6 | A |
| Example 3 | 1.0 | A | 18 | A | 0.4 | A | 0.7 | A |
| Example 4 | 1.3 | A | 35 | B | 0.3 | A | 1.2 | B |
| Example 5 | 1.7 | A | 32 | B | 0.3 | A | 0.8 | A |
| Example 6 | 0.8 | A | 16 | A | 0.7 | A | 0.5 | A |
| Comparative | 0.2 | B | 35 | B | 0.2 | A | — | — |
| Example 1 | | | | | | | | |
| Comparative | 0.3 | B | 25 | A | 0.4 | A | 0.3 | A |
| Example 2 | | | | | | | | |

| | | | Servo | | | |
|---|---|---|---|---|---|---|
| | | | signal quality | | | |
| | Durability | | (PS/N)/ | | PES | |
| | (Number) | Evaluation | (HS/N) | Evaluation | (%) | Evaluation |
| Example 1 | 0/100 | A | 105 | A | 6 | A |
| Example 2 | 1/100 | A | 102 | A | 4 | A |
| Example 3 | 0/100 | A | 98 | A | 3 | A |
| Example 4 | 2/100 | B | 94 | B | 9 | A |
| Example 5 | 1/100 | A | 93 | B | 12 | A |
| Example 6 | 3/100 | B | 86 | B | 9 | A |
| Comparative | 1/100 | A | 75 | C | 21 | B |
| Example 1 | | | | | | |
| Comparative | 0/100 | A | 71 | C | 17 | B |
| Example 2 | | | | | | |

What is claimed is:

1. A magnetic transfer master carrier obtained by
forming a perpendicular magnetic anisotropy magnetic layer over a surface of an original master which has a concavo-convex pattern,
placing a base material against the formed perpendicular magnetic anisotropy magnetic layer, and
separating the base material.

2. The magnetic transfer master carrier according to claim 1, wherein a functional layer is formed on the surface of the original master in advance, before the perpendicular magnetic anisotropy magnetic layer is formed.

3. The magnetic transfer master carrier according to claim 1, wherein perpendicular magnetic anisotropy of the perpendicular magnetic anisotropy magnetic layer is controlled.

4. The magnetic transfer master carrier according to claim 1, wherein the perpendicular magnetic anisotropy magnetic layer has a fine crystal grain structure.

5. The magnetic transfer master carrier according to claim 2, wherein the absolute value of an internal stress of the functional layer is 1 GPa or less.

6. A magnetic transfer method comprising:
initially magnetizing a perpendicular magnetic recording medium in a perpendicular direction,
closely attaching a magnetic transfer master carrier to the initially magnetized perpendicular magnetic recording medium, and
magnetically transferring information to the perpendicular magnetic recording medium by applying a perpendicular magnetic field which acts in the opposite direction to the direction of the initial magnetization, with the perpendicular magnetic recording medium and the magnetic transfer master carrier closely attached to each other,
wherein the magnetic transfer master carrier is produced by forming a perpendicular magnetic anisotropy magnetic layer over a surface of an original master which has a concavo-convex pattern, placing a base material against the formed perpendicular magnetic anisotropy magnetic layer, and separating the base material.

7. A method for producing a magnetic transfer master carrier, comprising:
forming a functional layer on a surface of an inverted concavo-convex pattern provided on an original master,
forming a perpendicular magnetic anisotropy magnetic layer on a surface of the functional layer, and
performing electroforming to form a base material, while the original master over which the perpendicular magnetic anisotropy magnetic layer has been formed serves as a matrix,
wherein the magnetic transfer master carrier comprises the base material having on its surface a concavo-convex pattern corresponding to information to be magnetically transferred to a perpendicular magnetic recording medium, and also comprises the perpendicular magnetic anisotropy magnetic layer formed on a surface of the concavo-convex pattern,
wherein the inverted concavo-convex pattern is an inversion of the concavo-convex pattern, and
wherein the functional layer includes a release layer and a perpendicular magnetic anisotropy providing layer.

8. The method according to claim 7, further comprising removing the functional layer which remains on a surface of the magnetic transfer master carrier having been separated from the original master, after the electroforming.

9. The method according to claim 7, wherein the absolute value of an internal stress of the functional layer is 1 GPa or less.
